(19) United States
(12) Patent Application Publication
(10) Pub. No.: US 2024/0294849 A1
(43) Pub. Date: Sep. 5, 2024

(54) FABRIC CARE COMPOSITION

(71) Applicants: Rohm and Haas Company, Collegeville, PA (US); Union Carbide Corporation, Seadrift, TX (US)

(72) Inventors: Daniel S. Miller, Phoenixville, PA (US); Randara Pulukkody, Lansdale, PA (US); Lyndsay M. Leal, Spring City, PA (US); Michelle Gallagher, Cherry Hill, NJ (US); Caroline Nimako-Boateng, Reading, PA (US); Jennifer P. Todd, Willow Grove, PA (US); Emmett M. Partain, III, Bound Brook, NJ (US)

(21) Appl. No.: 18/261,695

(22) PCT Filed: Mar. 9, 2022
(86) PCT No.: PCT/US2022/019471

§ 371 Date: Jul. 17, 2023

Related U.S. Application Data
(60) Provisional application No. 63/164,082, filed on Mar. 22, 2021.

(51) Int. Cl. C11D 3/22; C11D 1/83; C11D 3/37; C11D 3/50

(52) U.S. Cl. CPC C11D 3/227; C11D 1/83; C11D 3/3788; C11D 3/50; C11D 2111/12

(57) ABSTRACT

A fabric care composition is provided including water: a fragrance and a deposition aid polymer, wherein the deposition aid polymer is a dextran polymer functionalized with quaternary ammonium moieties: wherein the deposition aid polymer enhances deposition of the fragrance onto a fabric.

The present invention relates to a fabric care composition. In particular, the present invention relates to a fabric care composition comprising: water; a fragrance; and a deposition aid polymer, wherein the deposition aid polymer is a dextran polymer functionalized with quaternary ammonium moieties; and wherein the deposition aid polymer enhances deposition of the fragrance onto a fabric.

Use of cationic carbohydrate polymers in laundry detergents is known, as in, e.g., U.S. Pat. No. 6,833,347. However, this reference does not suggest the use of the modified polymers described herein.

A modified carbohydrate polymer having quaternary ammonium groups has been disclosed for use in fabric care by Eldredge, et al. in U.S. Patent Application Publication No. 20170335242. Eldredge, et al. disclose a fabric care composition comprising a modified carbohydrate polymer having quaternary ammonium groups having at least one C₈₋₂₂ alkyl or alkenyl group; wherein the modified carbohydrate polymer has a weight-average molecular weight of at least 500,000; and wherein at least 20 wt % of the quaternary ammonium groups on the at least one modified carbohydrate polymer have at least one C₈₋₂₂ alkyl or alkenyl group.

Notwithstanding, there remains a continuing need for fabric care compositions having a desirable balance of performance properties, including the deposition of fragrance on fabric. There is also a continuing need for new fabric care compositions having an increased natural origin index (ISO16128) when compared with conventional fabric care compositions.

The present invention provides a fabric care composition comprising: water; a fragrance; and a deposition aid polymer, wherein the deposition aid polymer is a dextran polymer functionalized with quaternary ammonium moieties; and wherein the deposition aid polymer enhances deposition of the fragrance onto a fabric.

The present invention provides a fabric care composition comprising: water; a cleaning surfactant; a fragrance; and a deposition aid polymer, wherein the deposition aid polymer is a dextran polymer functionalized with quaternary ammonium moieties; and wherein the deposition aid polymer enhances deposition of the fragrance onto a fabric.

The present invention provides a method of treating an article of laundry, comprising: providing an article of laundry; selecting a fabric care composition according to the present invention; providing a bath water; and applying the bath water and the fabric care composition to the article of laundry to provide a treated article of laundry; wherein the fragrance is associated with the treated article of laundry.

### DETAILED DESCRIPTION

It has been found that a fabric care composition including a fragrance in combination with a deposition aid polymer comprising a dextran polymer functionalized with quaternary ammonium moieties provides a surprisingly favorable balance of performance properties including the deposition of fragrance onto fabric (preferably, wherein the viscosity of the fabric care composition is not significantly thickened by more than by incorporation of the deposition aid polymer (i.e., <30% increase (more preferably, <20% increase) in viscosity of the fabric care composition upon addition of the deposition aid polymer).

Unless otherwise indicated, ratios, percentages, parts, and the like are by weight. Weight percentages (or wt %) in the composition are percentages of dry weight, i.e., excluding any water that may be present in the composition.

As used herein, unless otherwise indicated, the terms “weight average molecular weight” and “Mw” are used interchangeably to refer to the weight average molecular weight as measured in a conventional manner with gel permeation chromatography (GPC) and conventional standards, such as polyethylene glycol standards. GPC techniques are discussed in detail in Modem Size Exclusion Chromatography, W. W. Yau, J. J. Kirkland, D. D. Bly; Wiley-Interscience, 1979, and in A Guide to Materials Characterization and Chemical Analysis, J. P. Sibilia; VCH, 1988, p. 81-84. Weight average molecular weights are reported herein in units of Daltons.

Preferably, the fabric care composition of the present invention is selected from the group consisting of a fabric refresher formulation, a fabric softening formulation and a laundry detergent formulation. More preferably, the fabric care composition of the present invention is a laundry detergent formulation.

Preferably, the fabric care composition of the present invention, comprises: water (preferably, 10 to 99.9 wt % (more preferably, 25 to 94.825 wt %; still more preferably, 40 to 85 wt %; most preferably, 50 to 75 wt %), based on the weight of the fabric care composition, of water); a fragrance (preferably, 0.05 to 10 wt % (more preferably, 0.1 to 5 wt %; most preferably, 0.1 to 3 wt %), based on the weight of the fabric care composition, of the fragrance)(preferably, wherein the fragrance is selected from the group consisting of benzyl alcohol, citronellol, linalool, limonene and mixtures thereof; more preferably, wherein the fragrance includes citronellol); a deposition aid polymer (preferably, 0.05 to 5.0 wt %; more preferably, 0.075 to 3.0 wt %; still more preferably, 0.09 to 2.5 wt %; most preferably, 0.1 to 2.25 wt %), based on the weight of the fabric care composition, of the deposition aid polymer), wherein the deposition aid polymer is a dextran polymer (preferably, a branched chain dextran polymer) functionalized with quaternary ammonium moieties (preferably, wherein the deposition aid polymer has a Kjeldahl nitrogen content corrected for ash and volatiles, TKN, of ≥0.5 wt % (preferably, 0.5 to 5.0 wt %; more preferably, 0.5 to 4.0 wt %; still more preferably, 0.75 to 2.5 wt %; most preferably, 1 to 2 wt %); optionally, a cleaning surfactant (preferably, 0 to 89.9 wt % (more preferably, 5 to 75 wt %; still more preferably, 10 to 60 wt %; most preferably, 15 to 30 wt %), based on the weight of the fabric care composition, of the cleaning surfactant); wherein the deposition aid polymer enhances deposition of the fragrance from the fabric care composition onto a fabric (preferably, wherein the fabric is selected from the group consisting of cotton interlock, cotton, poly cotton blend and cotton terry; more preferably, wherein the fabric contains cotton; most preferably, wherein the fabric is cotton).

Preferably, the fabric care composition of the present invention is a liquid formulation. More preferably, the fabric care composition of the present invention is an aqueous liquid formulation.

Preferably, the fabric care composition of the present invention, comprises: 10 to 99.9 wt % (preferably, 25 to 94.825 wt %; more preferably, 40 to 85 wt %; most preferably, 50 to 75 wt %), based on the weight of the fabric care composition, of water. More preferable, the fabric care composition of the present invention, comprises: 10 to 99.9 wt % (preferably, 25 to 94.825 wt %; more preferably, 40 to 85 wt %; most preferably, 50 to 75 wt %), based on the weight of the fabric care composition, of water, wherein the water is at least one of distilled water and deionized water. Most preferably, the fabric care composition of the present invention, comprises: 10 to 99.9 wt % (preferably, 25 to 94.825 wt %; more preferably, 40 to 85 wt %; most preferably, 50 to 75 wt %), based on the weight of the fabric care composition, of water, wherein the water is distilled and deionized.

Preferably, the fabric care composition of the present invention, comprises: 0.05 to 10 wt % (preferably, 0.1 to 5 wt %; most preferably, 0.1 to 3 wt %), based on weight of the fabric care composition, of fragrance. More preferably, the fabric care composition of the present invention, comprises: 0.05 to 10 wt % (preferably, 0.1 to 5 wt %; most preferably, 0.1 to 3 wt %), based on weight of the fabric care composition, of fragrance; wherein the fragrance is selected from the group consisting of benzyl alcohol, citronellol, linalool, limonene and mixtures thereof. Most preferably, the fabric care composition of the present invention, comprises: 0.05 to 10 wt % (preferably, 0.1 to 5 wt %; most preferably, 0.1 to 3 wt %), based on weight of the fabric care composition, of fragrance; wherein the fragrance includes citronellol.

Preferably, the fabric care composition of the present invention comprises a deposition aid polymer; wherein the deposition aid polymer is a dextran polymer functionalized with quaternary ammonium moieties; wherein the deposition aid polymer enhances deposition of fragrance from the fabric care composition onto a fabric (preferably, a cotton fabric). More preferably, the fabric care composition of the present invention comprises 0.05 to 5.0 wt % (preferably, 0.075 to 3.0 wt %; more preferably, 0.09 to 2.5 wt %; most preferably, 0.1 to 2.25 wt %), based on weight of the fabric care composition, of a deposition aid polymer; wherein the deposition aid polymer is a dextran polymer functionalized with quaternary ammonium moieties; wherein the deposition aid polymer enhances deposition of fragrance from the fabric care composition onto a fabric (preferably, a cotton fabric). Most preferably, the fabric care composition of the present invention comprises 0.05 to 5.0 wt % (preferably, 0.075 to 3.0 wt %; more preferably, 0.09 to 2.5 wt %; most preferably, 0.1 to 2.25 wt %), based on weight of the fabric care composition, of a deposition aid polymer; wherein the deposition aid polymer is a dextran polymer functionalized with quaternary ammonium moieties; wherein the deposition aid polymer enhances deposition of fragrance from the fabric care composition onto a fabric (preferably, a cotton fabric); wherein the deposition aid polymer has a Kjeldahl nitrogen content corrected for ash and volatiles, TKN, of ≥0.5 wt % (preferably, 0.5 to 5.0 wt %; more preferably, 0.5 to 4.0 wt %; still more preferably, 0.75 to 2.5 wt %; most preferably, 1 to 2 wt %) (measured using a Buchi KjelMaster K-375 automated analyzer, corrected for volatiles and ash measured as described in ASTM method D-2364); wherein the deposition aid polymer enhances deposition of fragrance from the fabric care composition onto a fabric (preferably, a cotton fabric).

Preferably, the deposition aid polymer is a dextran polymer functionalized with quaternary ammonium moieties; wherein the dextran polymer has a weight average molecular weight of 50,000 to 3,000,000 Daltons (preferably, 100,000 to 2,000,000 Daltons; more preferably, 125,000 to 1,000,000 Daltons; still more preferably, 130,000 to 650,000 Daltons; most preferably, 145,000 to 525,000 Daltons). More preferably, the deposition aid polymer is a dextran polymer functionalized with quaternary ammonium moieties; wherein the dextran polymer has a weight average molecular weight of 50,000 to 3,000,000 Daltons (preferably, 100,000 to 2,000,000 Daltons; more preferably, 125,000 to 1,000,000 Daltons; still more preferably, 130,000 to 650,000 Daltons; most preferably, 145,000 to 525,000 Daltons); and wherein the dextran polymer is a branched chain dextran polymer comprising a plurality of glucose structural units; wherein 90 to 98 mol % (preferably, 92.5 to 97.5 mol %; more preferably, 93 to 97 mol %; most preferably, 94 to 96 mol %) of the glucose structural units are connected by α-D-1,6 linkages and 2 to 10 mol % (preferably, 2.5 to 7.5 mol %; more preferably, 3 to 7 mol %; most preferably, 4 to 6 mol %) of the glucose structural units are connected by α-1,3 linkages. Most preferably, the deposition aid polymer is a dextran polymer functionalized with quaternary ammonium moieties; wherein the dextran polymer has a weight average molecular weight of 50,000 to 3,000,000 Daltons (preferably, 100,000 to 2,000,000 Daltons; more preferably, 125,000 to 1,000,000 Daltons; still more preferably, 130,000 to 650,000 Daltons; most preferably, 145,000 to 525,000 Daltons); wherein the dextran polymer is a branched chain dextran polymer comprising a plurality of glucose structural units; wherein 90 to 98 mol % (preferably, 92.5 to 97.5 mol %; more preferably, 93 to 97 mol %; most preferably, 94 to 96 mol %) of the glucose structural units are connected by α-D-1,6 linkages and 2 to 10 mol % (preferably, 2.5 to 7.5 mol %; more preferably, 3 to 7 mol %; most preferably, 4 to 6 mol %) of the glucose structural units are connected by α-1,3 linkages according to formula I

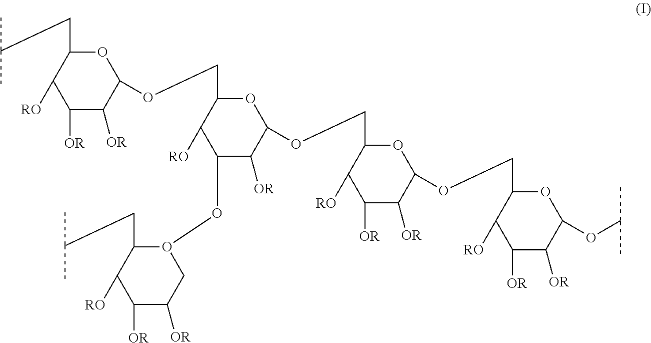

wherein R is selected from a hydrogen, a C₁₋₄ alkyl group and a hydroxy C₁₋₄ alkyl group; and wherein the average branch off the dextran polymer backbone is ≤3 anhydroglucose units.

Preferably, the dextran polymer contain less than 0.01 wt %, based on weight of the dextran polymer, of alternan. More preferably, the dextran polymer contain less than 0.001 wt %, based on weight of the dextran polymer, of alternan. Most preferably, the dextran polymer contain less than the detectable limit of alternan.

Preferably, the deposition aid polymer is a dextran polymer functionalized with quaternary ammonium moieties; wherein the quaternary ammonium moieties are of formula (A) bound to a pendant oxygen on the dextran polymer

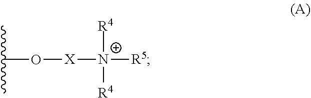

wherein

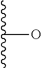 [SMILES: *O]

is a pendant oxygen on the dextran polymer; wherein X is a divalent linking group bonding the quaternary ammonium moiety to the pendent oxygen on the dextran polymer (preferably, wherein X is selected from divalent hydrocarbon groups, which may optionally be substituted (e.g., with a hydroxy group, an alkoxy group, an ether group); more preferably, wherein X is a —CH₂CH(OR⁶)CH₂— group; wherein R⁶ is selected from the group consisting of a hydrogen and a C₁₋₄ alkyl group (preferably, a hydrogen); most preferably, X is a —CH₂CH(OH)CH₂— group); wherein each R⁴ is independently selected from the group consisting of a C₁₋₇ alkyl group (preferably, a C₁₋₃ alkyl group; more preferably, a methyl group and an ethyl group; most preferably, a methyl group); and wherein R⁵ is selected from the group consisting of a C₁₋₂₂ alkyl group (preferably, selected from the group consisting of a C₁₋₃ alkyl group and a C₆₋₂₂ alkyl group; more preferably, a methyl group and an ethyl group; most preferably, a methyl group). More preferably, the deposition aid polymer is a cationic dextran polymer; wherein the cationic dextran polymer, comprises a dextran polymer functionalized with quaternary ammonium groups; wherein the quaternary ammonium groups are selected from the group consisting of quaternary ammonium moieties of formula (B) bound to a pendent oxygen on the dextran polymer

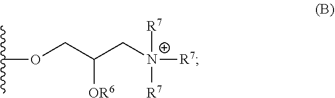

wherein R⁶ is selected from the group consisting of a hydrogen and a C₁₋₄ alkyl group (preferably, a hydrogen); and wherein each R⁷ is independently selected from the group consisting of a methyl group and an ethyl group (preferably, a methyl group).

Preferably, the deposition aid polymer comprises <0.001 meq/gram (preferably, <0.0001 meq/gram; more preferably, <0.00001 meq/gram; most preferably, <detectable limit) of aldehyde functionality.

Preferably, the deposition aid polymer comprises <0.1% (preferably, <0.01%; more preferably, <0.001%; most preferably, <detectable limit), of the linkages between individual glucose units in the deposition aid polymer are β-1,4 linkages.

Preferably, the deposition aid polymer comprises <0.1% (preferably, <0.01%; more preferably, <0.001%; most preferably, <detectable limit), of the linkages between individual glucose units in the deposition aid polymer are β-1,3 linkages.

Preferably, the deposition aid polymer comprises <0.001 meq/gram (preferably, <0.0001 meq/gram; more preferably, <0.00001 meq/gram; most preferably, <detectable limit) of silicone containing functionality.

Preferably, the fabric care composition of the present invention, further comprises: a cleaning surfactant. More preferably, the fabric care composition of the present invention, comprises: 0 to 89.9 wt % (preferably, 5 to 75 wt %; more preferably, 10 to 60 wt %; most preferably, 15 to 30 wt %), based on the weight of the fabric care composition, of a cleaning surfactant. Still more preferably, the fabric care composition of the present invention, comprises: 5 to 89.9 wt % (preferably, 5 to 75 wt %; more preferably, 10 to 60 wt %; most preferably, 15 to 30 wt %), based on the weight of the fabric care composition, of a cleaning surfactant; wherein the cleaning surfactant is selected from the group consisting of anionic surfactants, nonionic surfactants, cationic surfactants, amphoteric surfactants and mixtures thereof. Yet still more preferably, the fabric care composition of the present invention, comprises: 5 to 89.9 wt % (preferably, 5 to 75 wt %; more preferably, 10 to 60 wt %; most preferably, 15 to 30 wt %), based on the weight of the fabric care composition, of a cleaning surfactant; wherein the cleaning surfactant is selected from the group consisting of a mixture including an anionic surfactant and a non-ionic surfactant. Most preferably, the fabric care composition of the present invention, comprises: 5 to 89.9 wt % (preferably, 5 to 75 wt %; more preferably, 10 to 60 wt %; most preferably, 15 to 30 wt %), based on the weight of the fabric care composition, of a cleaning surfactant; wherein the cleaning surfactant includes a mixture of a linear alkyl benzene sulfonate, a sodium lauryl ethoxysulfate and a nonionic alcohol ethoxylate.

Anionic surfactants include alkyl sulfates, alkyl benzene sulfates, alkyl benzene sulfonic acids, alkyl benzene sulfonates, alkyl polyethoxy sulfates, alkoxylated alcohols, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenols, alkyl phenol polyethoxy ether sulfates, 2-acryloxy-alkane-1-sulfonic acid, 2-acryloxy-alkane-1-sulfonate, beta-alkyloxy alkane sulfonic acid, beta-alkyloxy alkane sulfonate, amine oxides and mixtures thereof. Preferred anionic surfactants include C₈₋₂₀ alkyl benzene sulfates, C₈₋₂₀ alkyl benzene sulfonic acid, C₈₋₂₀ alkyl benzene sulfonate, paraffin sulfonic acid, paraffin sulfonate, alpha-olefin sulfonic acid, alpha-olefin sulfonate, alkoxylated alcohols, C₈₋₂₀ alkyl phenols, amine oxides, sulfonates of fatty acids, sulfonates of fatty acid esters and mixtures thereof. More preferred anionic surfactants include C₁₂₋₁₆ alkyl benzene sulfonic acid, C₁₂₋₁₆ alkyl benzene sulfonate, C₁₂₋₁₈ paraffin-sulfonic acid, C₁₂₋₁₈ paraffin-sulfonate and mixtures thereof.

Non-ionic surfactants include secondary alcohol ethoxylates, ethoxylated 2-ethylhexanol, ethoxylated seed oils, butanol caped ethoxylated 2-ethylhexanol and mixtures thereof. Preferred non-ionic surfactants include secondary alcohol ethoxylates.

Cationic surfactants include quaternary surface active compounds. Preferred cationic surfactants include quaternary surface active compounds having at least one of an ammonium group, a sulfonium group, a phosphonium group, an iodinium group and an arsonium group. More preferred cationic surfactants include at least one of a dialkyldimethylammonium chloride and alkyl dimethyl benzyl ammonium chloride. Still more preferred cationic surfactants include at least one of C₁₆₋₁₈ dialkyldimethylammonium chloride, a C₈₋₁₈ alkyl dimethyl benzyl ammonium chloride di-tallow dimethyl ammonium chloride and di-tallow dimethyl ammonium chloride. Most preferred cationic surfactant includes di-tallow dimethyl ammonium chloride.

Amphoteric surfactants include betaines, amine oxides, alkylamidoalkylamines, alkyl-substituted amine oxides, acylated amino acids, derivatives of aliphatic quaternary ammonium compounds and mixtures thereof. Preferred amphoteric surfactants include derivatives of aliphatic quaternary ammonium compounds. More preferred amphoteric surfactants include derivatives of aliphatic quaternary ammonium compounds with a long chain group having 8 to 18 carbon atoms. Still more preferred amphoteric surfactants include at least one of C₁₂₋₁₄ alkyldimethylamine oxide, 3-(N,N-dimethyl-N-hexadecyl-ammonio)propane-1-sulfonate, 3-(N,N-dimethyl-N-hexadecylammonio)-2-hydroxypropane-1-sulfonate. Most preferred amphoteric surfactants include at least one of C₁₂₋₁₄ alkyldimethylamine oxide.

Preferably, the fabric care composition of the present invention is a laundry detergent.

Preferably, the fabric care composition of the present invention is a laundry detergent. Preferably, the laundry detergent optionally comprises additives selected from the group consisting of builders (e.g., sodium citrate), hydrotropes (e.g., ethanol, propylene glycol), enzymes (e.g., protease, lipase, amylase), preservatives, fluorescent whitening agents, dyes, additive polymers, rheology modifiers, suspension agents, fabric softening silicones and mixtures thereof.

Preferably, the fabric care composition of the present invention, optionally further comprises: a fabric softening silicone. More preferably, the fabric care composition of the present invention, comprises: 0.05 to 10 wt % (preferably, 0.1 to 5 wt %; more preferably, 0.1 to 3 wt %), based on the weight of the fabric care composition, of a fabric softening silicone. Still more preferably, the fabric care composition of the present invention, comprises: 0.05 to 10 wt % (preferably, 0.1 to 5 wt %; more preferably, 0.1 to 3 wt %), based on the weight of the fabric care composition, of a fabric softening silicone; wherein the fabric softening silicone is selected from the group consisting of a nitrogen free silicone polymer, an anionic silicone polymer and mixtures thereof. Most preferably, the fabric care composition of the present invention, comprises: 0.05 to 10 wt % (preferably, 0.1 to 5 wt %; more preferably, 0.1 to 3 wt %), based on the weight of the fabric care composition, of a fabric softening silicone; wherein the fabric softening silicone is selected from the group consisting of a nitrogen free silicone polymer, an anionic silicone polymer and mixtures thereof; and wherein the fabric softening silicone is in the form of an emulsion.

Preferred nitrogen free silicone polymers include nonionic nitrogen free silicone polymers, zwitterionic nitrogen free silicone polymers, amphoteric nitrogen free silicone polymers and mixtures thereof. Preferred nitrogen free silicone polymers have formula (1), (2) or (3)(preferably, formula (1) or (3)):

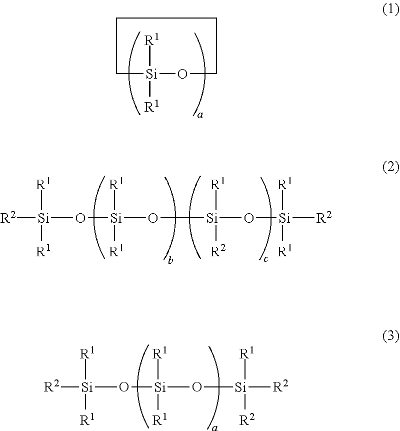

wherein each R¹ is independently selected from the group consisting of a C₁₋₂₀ alkyl group, a C₂₋₂₀ alkenyl group, a C₆₋₂₀ aryl group, a C₇₋₂₀ arylalkyl group, a C₇₋₂₀ alkylaryl group, a C₇₋₂₀ arylalkenyl group and a C₇₋₂₀ alkenylaryl group (preferably, wherein R¹ is selected from the group consisting of a methyl group, a phenyl group and a phenylalkyl group); wherein each R² is independently selected from the group consisting of a C₁₋₂₀ alkyl group, a C₂₋₂₀ alkenyl group, a C₆₋₂₀ aryl group, a C₇₋₂₀ arylalkyl group, a C₇₋₂₀ alkylaryl group, a C₇₋₂₀ arylalkenyl group, a C₇₋₂₀ alkenylaryl group and a poly(ethyleneoxide/propyleneoxide) copolymer group having formula (4)

—(CH₂)ₙO(C₂H₄O)ₘ(C₃H₆O)ₚR³ (4)

wherein each R³ is independently selected from the group consisting of a hydrogen, a C₁₋₄ alkyl group and an acetyl group; wherein at least one R² is a poly(ethyleneoxy/propyleneoxy) copolymer group having formula (4); wherein a has a value such that the viscosity of the nitrogen free silicone polymer according to formula (1) or formula (3) is 2 to 50,000,000 centistokes at 20° C. (preferably, 10,000 to 800,000 centistokes at 20° C.); wherein b is 1 to 50 (preferably, 1 to 30); wherein c is 1 to 50 (preferably, 1 to 30); wherein n is 1 to 50 (preferably, 3 to 5); wherein m is 1 to 100 (preferably, 6 to 100); wherein p is 0 to 14 (preferably, 0 to 3); wherein m+p is 5 to 150 (preferably, 7 to 100)(preferably, wherein R² is selected from the group consisting of a methyl group, a phenyl group, a phenylalkyl group and from the group having formula (4)). Most preferred nitrogen free silicone polymers have formula (3), wherein R¹ is a methyl and wherein a has a value such that the viscosity of the nitrogen free silicone polymer is 60,000 to 700,000 centistokes at 20° C.

Preferred nitrogen free silicone polymers include anionic silicone polymers. Anionic silicone polymers are described, for example, in The Encyclopedia of Polymer Science, volume 11, p. 765. Examples of anionic silicone polymers include silicones that incorporate carboxylic, sulphate, sulphonic, phosphate and/or phosphonate functionality. Preferred anionic silicone polymers incorporated carboxyl functionality (e.g., carboxylic acid or carboxylate anion). Preferred anionic silicone polymers have a weight average molecular weight of 1,000 to 100,000 Daltons (preferably, 2,000 to 50,000 Daltons; more preferably, 5,000 to 50,000 Daltons; most preferably, 10,000 to 50,000 Daltons). Preferably, the anionic silicone polymer has an anionic group content of at least 1 mol % (more preferably, at least 2 mol %). Preferably, the anionic groups on the anionic silicone polymer are not located on the terminal position of the longest linear silicone chain. Preferred anionic silicone polymers have anionic groups at a midchain position on the silicone. More preferred anionic silicone polymers have anionic groups located at least 5 silicone atoms from a terminal position on the longest linear silicone chain in the anionic silicone polymer.

Preferably, the fabric care composition of the present invention further comprises: 0 to 10 wt % (preferably, 1 to 10 wt %; more preferably, 2 to 8 wt %; most preferably, 5 to 7.5 wt %), based on the weight of the fabric care composition, of a hydrotrope. More preferably, the fabric care composition of the present invention further comprises: 0 to 10 wt % (preferably, 1 to 10 wt %; more preferably, 2 to 8 wt %; most preferably, 5 to 7.5 wt %), based on the weight of the fabric care composition, of a hydrotrope; wherein the hydrotrope is selected from the group consisting of alkyl hydroxides; glycols, urea; monoethanolamine; diethanolamine; triethanolamine; calcium, sodium, potassium, ammonium and alkanol ammonium salts of xylene sulfonic acid, toluene sulfonic acid, ethylbenzene sulfonic acid and cumene sulfonic acid; salts thereof and mixtures thereof. Still more preferably, the fabric care composition of the present invention further comprises: 0 to 10 wt % (preferably, 1 to 10 wt %; more preferably, 2 to 8 wt %; most preferably, 5 to 7.5 wt %), based on the weight of the fabric care composition, of a hydrotrope; wherein the hydrotrope is selected from the group consisting of ethanol, propylene glycol, sodium toluene sulfonate, potassium toluene sulfonate, sodium xylene sulfonate, ammonium xylene sulfonate, potassium xylene sulfonate, calcium xylene sulfonate, sodium cumene sulfonate, ammonium cumene sulfonate and mixtures thereof. Yet still more preferably, the fabric care composition of the present invention further comprises: 0 to 10 wt % (preferably, 1 to 10 wt %; more preferably, 2 to 8 wt %; most preferably, 5 to 7.5 wt %), based on the weight of the fabric care composition, of a hydrotrope; wherein the hydrotrope includes at least one of ethanol, propylene glycol and sodium xylene sulfonate. Most preferably, the fabric care composition of the present invention further comprises: 0 to 10 wt % (preferably, 1 to 10 wt %; more preferably, 2 to 8 wt %; most preferably, 5 to 7.5 wt %), based on the weight of the fabric care composition, of a hydrotrope; wherein the hydrotrope is a mixture of ethanol, propylene glycol and sodium xylene sulfonate.

Preferably, the fabric care composition of the present invention further comprises: 0 to 30 wt % (preferably, 0.1 to 15 wt %; more preferably, 1 to 10 wt %), based on the weight of the fabric care composition, of a builder. More preferably, the fabric care composition of the present invention further comprises: 0 to 30 wt % (preferably, 0.1 to 15 wt %; more preferably, 1 to 10 wt %), based on the weight of the fabric care composition, of a builder; wherein the builder is selected from the group consisting of inorganic builders (e.g., tripolyphosphate, pyrophosphate); alkali metal carbonates; borates; bicarbonates; hydroxides; zeolites; citrates (e.g., sodium citrate); polycarboxylates; monocarboxylates; aminotrismethylenephosphonic acid; salts of aminotrismethylenephosphonic acid; hydroxyethanediphosphonic acid; salts of hydroxyethanediphosphonic acid; diethylenetriaminepenta(methylenephosphonic acid); salts of diethylenetriaminepenta(methylenephosphonic acid); ethylenediaminetetraethylene-phosphonic acid; salts of ethylenediaminetetraethylene-phosphonic acid; oligomeric phosphonates; polymeric phosphonates; mixtures thereof. Most preferably, the fabric care composition of the present invention further comprises: 0 to 30 wt % (preferably, 0.1 to 15 wt %; more preferably, 1 to 10 wt %), based on the weight of the fabric care composition, of a builder; wherein the builder includes a citrate (preferably, a sodium citrate).

Preferably, the fabric care composition is in a liquid form having a pH from 6 to 12.5; preferably at least 6.5, preferably at least 7, preferably at least 7.5; preferably no greater than 12.25, preferably no greater than 12, preferably no greater than 11.5. Suitable bases to adjust the pH of the formulation include mineral bases such as sodium hydroxide (including soda ash) and potassium hydroxide; sodium bicarbonate, sodium silicate, ammonium hydroxide; and organic bases such as mono-, di- or tri-ethanolamine; or 2-dimethylamino-2-methyl-1-propanol (DMAMP). Mixtures of bases may be used. Suitable acids to adjust the pH of the aqueous medium include mineral acid such as hydrochloric acid, phosphorus acid, and sulfuric acid; and organic acids such as acetic acid. Mixtures of acids may be used. The formulation may be adjusted to a higher pH with base and then back titrated to the ranges described above with acid.

The present invention provides a method of treating an article of laundry, comprising: providing an article of laundry; providing a fabric care composition of the present invention; providing a bath water; and applying the bath water and the fabric care composition to the article of laundry (preferably, wherein the article of laundry is a fabric selected from the group consisting of cotton interlock, cotton, poly cotton blend and cotton terry; more preferably, wherein the fabric contains cotton; most preferably, wherein the fabric is cotton) to provide a treated article of laundry; wherein the fragrance is associated with the treated article of laundry (preferably, wherein the fragrance is not covalently bonded to the treated article of laundry). More preferably, the present invention provides a method of treating an article of laundry, comprising: providing an article of laundry (preferably, wherein the article of laundry is a fabric selected from the group consisting of cotton interlock, cotton, poly cotton blend and cotton terry; more preferably, wherein the fabric contains cotton; most preferably, wherein the fabric is cotton); providing a fabric care composition of the present invention; providing a bath water; and applying the bath water and the fabric care composition to the article of laundry to provide a treated article of laundry; wherein the fragrance is associated with the treated article of laundry (preferably, wherein the fragrance is not covalently bonded to the treated article of laundry) and wherein the deposition aid polymer improves the laundry delivery efficacy of the fragrance.

Some embodiments of the present invention will now be described in detail in the following Examples.

The modified carbohydrate polymers in the Examples were characterized as follows.

The volatiles and ash content (measured as sodium chloride) were determined as described in ASTM method D-2364.

The total Kjeldahl nitrogen content (TKN) was determined in duplicate using a Buchi KjelMaster K-375 automatic Kjeldahl analyzer. The TKN values were corrected for volatiles and ash.

### Example S1: Synthesis of Cationic Dextran Polymer

A 500 mL, four necked, round bottom flask fitted with a rubber serum cap, a nitrogen inlet, a pressure equalizing addition funnel, a stirring paddle and motor, a subsurface thermocouple connected to a J-KEM controller and a Friedrich condenser connected to a mineral oil bubbler was charged with dextran (30.33 g; Aldrich product #D4876) and deionized water (160.75 g). The addition funnel was charged with a 70% aqueous solution of 2,3-epoxypropyltrimethylammonium chloride (27.13 g; QUAB® 151 available from SKW QUAB Chemicals). The flask contents were allowed to stir until the dextran dissolved in the deionized water. While the contents were stirring, the apparatus was purged with nitrogen to displace any oxygen entrained in the system. The nitrogen flow rate was about 1 bubble per second. The mixture was purged with nitrogen while stirring for one hour. Using a plastic syringe, a 25% aqueous sodium hydroxide solution (4.76 g) was added over a period of a few minutes to the flask contents with stirring under nitrogen. The flask contents were then allowed to stir under nitrogen for 30 minutes. The contents of the addition funnel were then charged to the flask contents dropwise over a few minutes under nitrogen with continued stirring. After the contents of the addition funnel were transferred to the flask contents, the mixture was allowed to stir for 5 minutes. Then heat was applied to the flask contents with a heating mantle controlled using the J-KEM controller set at 55° C. The flask contents were heated to and maintained at 55° C. for 90 minutes. The flask contents were then cooled to room temperature while maintaining a positive nitrogen pressure in the flask. When the flask contents reached room temperature, acetic acid (2.50 g) was added dropwise to the flask contents via a syringe and the flask contents were stirred for 5 minutes. The polymer was recovered by non-solvent precipitation of the aqueous solution with an excess of methanol. The precipitated cationic dextran polymer was then recovered by filtration through a Buchner funnel and dried overnight in vacuo at 50° C. The product branched chain cationic dextran polymer was an off-white solid (24.3 g), with a volatiles content of 3.65%, an ash content of 0.37% (as sodium chloride). The volatiles and ash were measured as described in ASTM method D-2364. The Kjeldahl nitrogen content was measured using a Buchi KjelMaster K-375 automated analyzer and was found to be 1.41% (corrected for volatiles and ash), which corresponds to a trimethylammonium degree of substitution, CS, of 0.19. The weight average molecular weight, Mw, of the product cationic dextran polymer was 1,820,000 Daltons.

### Example S2: Fragrance

A fragrance solution was prepared having the composition noted in TABLE 1.

TABLE 1

Component (wt %)

| | Benzyl | | | |
|---|---|---|---|---|
| Example S2 | alcohol | Citronellol | Linalool | Limonene |
| Fragrance | 25 | 25 | 25 | 25 |
| solution | | | | |

### Comparative Examples CF1-CF3 and Example F1: Fabric Care Composition

Fabric care compositions were prepared in each of Comparative Examples CF1-CF3 and Example F1 having the formulation as described in TABLE 2 and prepared by standard laundry formulation preparation procedure.

TABLE 2

| | | | |
|---|---|---|---|
| CF1 | CF2 | CF3 | F1 |

| | |
|---|---|
| Ingredient | wt % |

| | | | | |
|---|---|---|---|---|
| Linear alkyl benzene sulfonate¹ | 8 | 8 | 8 | 8 |
| Sodium lauryl ethoxysulfate² | 6 | 6 | 6 | 6 |
| Propylene glycol | 5 | 5 | 5 | 5 |
| Ethanol | 2 | 2 | 2 | 2 |
| Nonionic alcohol ethoxylate³ | 6 | 6 | 6 | 6 |
| Sodium citrate | 5 | 5 | 5 | 5 |
| Example S1 | 0 | 0 | 0 | 1 |
| Cationic hydroxyethylcellulose⁴ | 0 | 1 | 0 | 0 |
| Diethylaminoethyl Dextran⁵ | 0 | 0 | 1 | 0 |
| Example S2 (fragrance) | 1 | 1 | 1 | 1 |

| | |
|---|---|
| NaOH (10% solution) | Adjust pH to 8.0 |
| Deionized water | q.s. 100 |

¹Nacconol 90G available from Stepan Company
²Steol CS-460 available from Stepan Company
³Biosoft N25-7 available from Stepan Company
⁴UCARE ™ JR 125 available from The Dow Chemical Company
⁵available from Sigma Aldrich under catalog number D9885.

### Fragrance In-Wash Deposition

The fragrance in wash deposition of the fragrance containing fabric care compositions was evaluated for each of the compositions of Comparative Examples CF1-CF3 and Example F1 on cotton with five replicates for each fragrance containing fabric care composition. The cotton was laundered with the fragrance containing fabric care compositions using the following procedure. Cut one cotton disk for each experiment and record the initial dry mass. Add 20 mL of 200 ppm (3:1 Calcium:Magnesium by weight) water to a 25 mL vial. Add a magnetic stir bar and then 0.4 g of the fragrance containing fabric care composition to the vial. Stir at 1,000 rpm on a 15 position stir plate. Add one cotton disk to the vial and wash for 15 minutes. Dump the solution and add 200 mL of 200 ppm water and rinse for 3 minutes. Remove the cotton disk and place on a drying rack for a drying time of 40 minutes or 60 minutes as noted in TABLE 5. Add the dried disk to a 20 mL gas chromatograph (CG) headspace vial and crimp seal immediately. Record the final mass.

### Gas Chromatography/Mass Spectrometry Analysis

The mass of fragrance deposited onto the fabric using each of the fragrance containing fabric care compositions of Comparative Examples CF1-CF3 and Example F1 was quantified by gas chromatography/mass spectrometry (GC-MS) using an Agilent 7890B GC with 5977 MS detector and an Agilent 7697A headspace sampler with the settings noted in TABLES 3 and 4. Standards of the four fragrances (benzyl alcohol, citronellol, linalool, and limonene) were prepared in hexanes by weight (ranging in concentration from 10-1000 ppm, wt/wt). The standards were prepared for headspace GC-MS analysis by weighing 10-15 mg of each calibration mix into 22 mL headspace vials and capping with Teflon-lined septa. The headspace analysis of the standards was done in a full-evaporation mode to eliminate matrix effects that can occur in static headspace sampling. In this mode, a small sample size is used, and the headspace vial temperature is set sufficiently high to allow for full evaporation of the volatile of interest. A calibration plot was prepared for each individual fragrance using at least five standard concentrations for that compound. The mg amount of each fragrance in each sample was then determined using the linear-least-squares equation from the calibration plot for that compound. The mg amount detected in each piece of fabric was then converted to ng of fragrance. The average mass of fragrance components (in ng) detected on the surface of the test fabrics for the five replicates is reported in TABLE 5.

TABLE 3
GC-MS Parameters

| | |
|---|---|
| Column: | DB-Wax UI: 30 m × 0.25 mm × 0.5 μm |
| | Model number: Agilent 122-7033UI |
| | Mode: Constant pressure |
| | Nominal initial pressure: 11.853 psi |
| | Average velocity: 43.122 cm/second |
| | Gas type: Helium |
| Inlet | Mode: Split |
| | Temperature: 240° C. |
| | Pressure: 11.853 psi |
| | Split ratio: 10:1 |
| | Split flow: 14 mL/minute |
| | Total flow: 18.4 mL/minute |
| Oven program | Initial temperature: 50° C., hold for 2 minutes |
| | Temperature ramp: 20° C./minute |
| | Final temperature: 230° C., hold for 8 minutes |
| | Total run time: 19 minutes |
| Mass detector | Acquisition mode: SIM |
| | Number of ions: 8 (m/z 41, 43, 68, 69, 71, 79, 93, 108) |
| | Total dwell time: 400 ms (50 ms/ion) |
| | Solvent delay: 5 minutes |
| | Resulting EM voltage: 1044.131 |
| | Quad/source temps: 150° C./230° C. |

TABLE 4
Headspace Autosampler Parameters

| Oven temperature: | 200° | C. |
|---|---|---|
| Loop temperature: | 220° | C. |
| Transfer line temperature: | 230° | C. |
| Vial equilibrium time: | 10 or 30 minutes | |
| Loop size: | 1 | mL |
| Fill pressure: | 15 | psi |
| Pressurization time | 2.0 | minutes |
| Injection time: | 0.2 | minutes |

| | |
|---|---|
| GC cycle time: | 27 or 57 minutes |

TABLE 5

| | Drying | Fragrance component (ng) | | | | | | |
|---|---|---|---|---|---|---|---|---|
| Fabric care | time | | | | | | Benzyl | |
| composition | (min.) | Limonene | | Linalool | Citronellol | | alcohol | |
| Comp. Ex. CF1 | 40 | 22 | (±3) | 0 | 5 | (±2) | 71 | (±10) |
| Comp. Ex. CF1 | 60 | 2 | (±0) | 0 | 2 | (±1) | 9 | (±1) |
| Comp. Ex. CF2 | 60 | 7 | (±1) | 0 | 3 | (±1) | 31 | (±6) |
| Comp. Ex. CF3 | 60 | 3 | (±1) | 0 | 2 | (±1) | 5 | (±1) |
| Example F1 | 40 | 62 | (±19) | 0 | 24 | (±14) | 126 | (±18) |
| Example F1 | 60 | 1 | (±0) | 0 | 14 | (±4) | 9 | (±1) |

### Viscosity Comparison

The viscosity of the fragrance containing fabric care composition of Comparative Examples CF1, CF3 and Example F1 was determined using an Anton Parr Dynamic Mechanical Analyzer (Model MCR 702 MultiDrive) in a cup and bob configuration. The cup diameter was 28.917 millimeters and the bob diameter was 26.656 millimeters. Twenty-five grams of the fragrance containing fabric care composition was loaded into the cup. The measurements were performed at a constant temperature of 25° C. A linear shear rate profile was applied to the sample. The range of shear rates was 1 to 100 s⁻¹ over a course of 550 seconds. The data reported in TABLE 6 is the viscosity measured at a shear rate of 20 s⁻¹.

TABLE 6

| Fabric Care Composition | Viscosity (mPa · s) |
|---|---|
| Comparative Example CF1 | 106.5 |
| Comparative Example CF3 | 1994.2 |
| F1 | 122.3 |

We claim:

1. A fabric care composition comprising:
water;
a fragrance; and
a deposition aid polymer, wherein the deposition aid polymer is a dextran polymer functionalized with quaternary ammonium moieties;
wherein the deposition aid polymer enhances deposition of the fragrance onto a fabric.

2. The fabric care composition of claim 1, further comprising a cleaning surfactant.

3. The fabric care composition of claim 2, wherein the fragrance is selected from the group consisting of benzyl alcohol, citronellol, linalool, limonene and mixtures thereof.

4. The fabric care composition of claim 3, wherein the deposition aid polymer has a Kjeldahl nitrogen content corrected for ash and volatiles of 0.5 to 5.0 wt %.

5. The fabric care composition of claim 4, wherein the deposition aid polymer is a branched chain dextran polymer functionalized with quaternary ammonium groups.

6. The fabric care composition of claim 5, wherein the branched chain dextran polymer comprises a plurality of glucose structural units; wherein 90 to 98 mol % of the glucose structural units are connected by α-D-1,6 linkages and 2 to 10 mol % of the glucose structural units are connected by α-1,3 linkages.

7. The fabric care composition of claim 6, wherein the fabric care composition is a laundry detergent.

8. The laundry detergent of claim 7, wherein the cleaning surfactant is selected from the group consisting of anionic surfactants, nonionic surfactants, cationic surfactants, amphoteric surfactants and mixtures thereof.

9. The laundry detergent of claim 8, wherein the cleaning surfactant includes a mixture of a linear alkyl benzene sulfonate, a sodium lauryl ethoxysulfate and a nonionic alcohol ethoxylate.

10. A method of treating an article of laundry, comprising: providing an article of laundry; selecting a fabric care composition according to claim 1; providing a bath water; and applying the bath water and the fabric care composition to the article of laundry to provide a treated article of laundry; wherein a fragrance is associated with the treated article of laundry.
